(19) United States
(12) Patent Application Publication
(10) Pub. No.: US 2023/0033253 A1
(43) Pub. Date: Feb. 2, 2023

(54) NETWORK SECURITY DEFENSE METHOD AND RELATED DEVICE APPLIED TO NETWORK SECURITY DEFENSE SYSTEM

(71) Applicants: CHINA NATIONAL DIGITAL SWITCHING SYSTEM ENGINEERING & TECHNOLOGICAL R&D CENTER, Henan, Zhengzhou (CN); ZHUHAI COMLEADER INFORMATION SCIENCE & TECHNOLOGY CORP., LTD., Zhuhai, Guangdong (CN)

(72) Inventors: Lei HE, Henan, Zhengzhou (CN); Jiangxing WU, Henan, Zhengzhou (CN); Qinrang LIU, Henan, Zhengzhou (CN); Ke SONG, Henan, Zhengzhou (CN); Quan REN, Henan, Zhengzhou (CN); Jun ZHOU, Henan, Zhengzhou (CN); Min FU, Henan, Zhengzhou (CN); Weili ZHANG, Henan, Zhengzhou (CN); Ruihao DING, Henan, Zhengzhou (CN); Yiwei GUO, Zhuhai, Guangdong (CN)

(21) Appl. No.: 17/791,277

(22) PCT Filed: Jun. 7, 2021
(86) PCT No.: PCT/CN2021/098595

§ 371 Date: Jul. 7, 2022

(30) Foreign Application Priority Data
Jun. 9, 2020 (CN) 202010526523.5

(51) Int. Cl. G06F 21/55; G06F 21/54; G06F 21/56

(52) U.S. Cl. CPC G06F 21/554; G06F 21/54; G06F 21/568

(57) ABSTRACT

Provided are a security defense method and apparatus applied to a network security defense system. The method includes: using memoryless technology in a cyberspace information system, where the memoryless technology includes technology which is not affected by generalized disturbance; eliminating a memory of the cyberspace information system on an effect of random disturbance by using a redundancy and replacement mechanism; and eliminating a memory of the cyberspace information system on an effect of non-random disturbance by eliminating a memory of a program running in the cyberspace information system and/or data in the cyberspace information system. The present solution can block a memory of the cyberspace information system on an error caused by the generalized disturbance including the non-random disturbance and the random disturbance, thereby improving security of the cyberspace information system.

This application claims priority to Chinese Patent Application No. 202010526523.5, titled “NETWORK SECURITY DEFENSE METHOD AND RELATED DEVICE APPLIED TO NETWORK SECURITY DEFENSE SYSTEM”, filed on Jun. 9, 2020, with the China National Intellectual Property Administration (CNIPA), which is incorporated herein by reference in its entirety.

### FIELD

The present disclosure relates to the field of network security, and in particular to a network security defense method and apparatus applied to a network security defense system.

### BACKGROUND

In general, various computers, information and communication devices in a cyberspace information system may be regarded as a certain expression of Turing machine, and they may receive, store and run a program that can be described by Turing machine. The program being run can perform the described algorithm. Therefore, the cyberspace information system may be abstracted as a reconfigurable memory channel with a processing capability.

Network security defense is a basic requirement of the cyberspace information system.

### SUMMARY

From the research, the applicant found that based on a feature of having a memory, if a disturbance, regardless of random disturbance or non-random disturbance, causes an error in a cyberspace information system at any moment, then the disturbance will certainly cause an error in the cyberspace information system after that moment due to the feature of the reconfigurable memory cyberspace information system. That is, there is also a memory on an effect of the disturbance on the cyberspace information system.

Therefore, it is possible to jump out of the existing security defense method “remediation afterwards” which is a restorative defense thinking pattern, and improve the security of the cyberspace information system through eliminating the memory of the cyberspace information system. Thus, the applicant proposes a network security defense system, and the technical solution of the present disclosure is a security defense method proposed based on the network security defense system.

A security defense method and apparatus applied to a network security defense system are provided according to the present disclosure, so as to improve the security of the cyberspace information system.

To achieve the above objective, a technical solution is provided in the present disclosure as follows.

A security defense method applied to a network security defense system, includes:

using memoryless technology in a cyberspace information system, where the memoryless technology includes technology which is not affected by generalized disturbance;

eliminating a memory of the cyberspace information system on an effect of random disturbance by using a redundancy and replacement mechanism; and

eliminating a memory of the cyberspace information system on an effect of non-random disturbance by eliminating a memory of a program running in the cyberspace information system and/or data in the cyberspace information system.

In an embodiment, the eliminating a memory of a program running in the cyberspace information system includes:

solidifying the program in the cyberspace information system, to make logic of the program unchangeable.

In an embodiment, the eliminating a memory of a program running in the cyberspace information system includes: solidifying the program in the cyberspace information system for a user, so that the user cannot change logic of the program.

In an embodiment, the eliminating a memory of a program running in the cyberspace information system includes:

comparing the program with a backup program of the program; and replacing the program with the backup program, in response to logic of the program being different from logic of the backup program.

In an embodiment, the eliminating a memory of a program running in the cyberspace information system includes at least one of the following: periodically or aperiodically recovering the program based on a preset recovery method in the program;

checking the program in real time or in non-real time based on a preset checking method; and

correcting the program in real time or in non-real time based on a preset encryption or error correction coding.

In an embodiment, the eliminating a memory of data in the cyberspace information system includes:

initializing a storage space of the data.

In an embodiment, the eliminating a memory of data in the cyberspace information system includes:

clearing a storage space of the data.

In an embodiment, the eliminating a memory of data in the cyberspace information system includes:

comparing the data with backup data of the data; and replacing the data with the backup data, in response to the data being different from the backup data.

In an embodiment, the eliminating a memory of data in the cyberspace information system includes:

checking or correcting the data based on a preset checking, encryption or error correction coding in the data; and

initializing the data, in response to a checking result indicating the data is changed.

A security defense apparatus applied to a network security defense system, includes:

a memoryless module, configured to use memoryless technology in a cyberspace information system, where the memoryless technology includes technology which is not affected by generalized disturbance;

a first memory elimination module, configured to eliminate an effect of time-related random disturbance on the cyberspace information system by using a redundancy and replacement mechanism; and

a second memory elimination module, configured to eliminate an effect of non-random disturbance on the cyberspace information system by eliminating a memory of a program running in the cyberspace information system and/or data in the cyberspace information system.

A security defense device applied to a network security defense system, includes a processor and a memory;

the memory is configured to store a program; and

the processor is configured to run the program, to implement the security defense method applied to a network security defense system described above.

A computer-readable storage medium storing a computer program,

the computer program, when running on a computer, implements the security defense method applied to a network security defense system described above.

A cyberspace information system includes:

a logic module, a storage module and a memory elimination module,

the logic module is configured to implement a logic function based on memoryless technology or a running program;

the storage module is configured to store data; and

the memory elimination module is configured to perform the security defense method applied to the network security defense system described above, to eliminate an effect of generalized disturbance on the cyberspace information system.

According to the technical solution in the present disclosure, memoryless technology is used in a cyberspace information system, and the memoryless technology includes technology which is not affected by generalized disturbance. A memory of the cyberspace information system on an effect of random disturbance is eliminated by using a redundancy and replacement mechanism. A memory of a program running in the cyberspace information system and data in the cyberspace information system is eliminated. The memoryless technology is used for the cyberspace information system to be not affected by the generalized disturbance, the redundancy and replacement mechanism is used to eliminate the memory of the cyberspace information system on the effect of the random disturbance, and the memory elimination is used to eliminate the memory of the cyberspace information system on the effect of the non-random disturbance. Therefore, the present solution can block a memory of the cyberspace information system on an error caused by the generalized disturbance including the non-random disturbance and the random disturbance, thereby improving security of the cyberspace information system.

### BRIEF DESCRIPTION OF THE DRAWINGS

In order to more clearly illustrate technical solutions in embodiments of the present disclosure or the conventional technology, the drawings to be used in the description of the embodiments or the conventional technology are briefly described below. Apparently, the drawings in the following description show only some embodiments of the present disclosure, and other drawings may also be obtained by those skilled in the art based on the provided drawings without any creative work.

FIG. 1 is a schematic structural diagram of a network security defense system;

FIG. 2 is a flow chart of a security defense method applied to a network security defense system according to an embodiment of the present disclosure;

FIG. 3 is a flow chart of a security defense method applied to a network security defense system according to another embodiment of the present disclosure; and

FIG. 4 is a schematic structural diagram of a cyberspace information system according to an embodiment of the present disclosure.

### DETAILED DESCRIPTION

The technical solutions in the embodiments of the present disclosure are described clearly and completely in conjunction with the drawings in the embodiments of the present disclosure hereinafter. It is apparent that the described embodiments are only some embodiments of the present disclosure, rather than all embodiments. All other embodiments obtained by those skilled in the art based on the embodiments of the present disclosure without any creative work fall within the protection scope of the present disclosure.

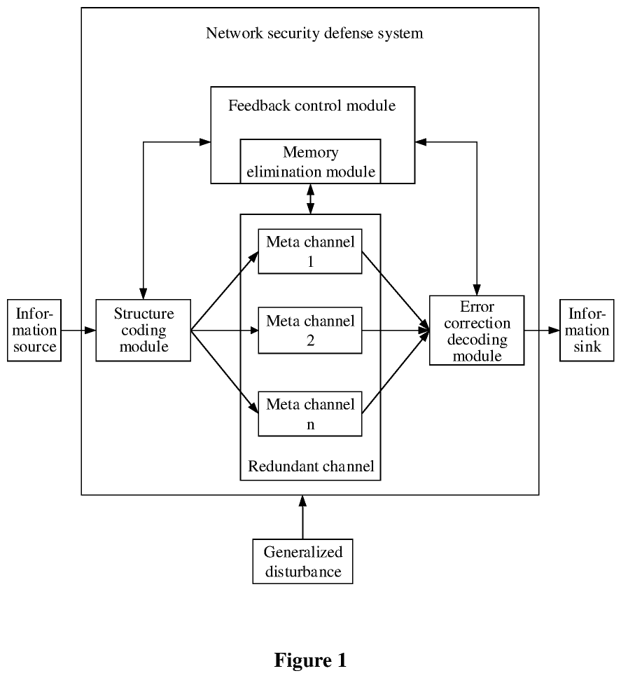

In order to improve the security of a cyberspace information system, the applicant proposes a network security defense system for the cyberspace information system. As shown in FIG. 1, highlights of the network security defense system are memory elimination and endogenous security. On the basis of FIG. 1, a specific technical means of the memory elimination is provided in the technical solution of the embodiment of the present disclosure.

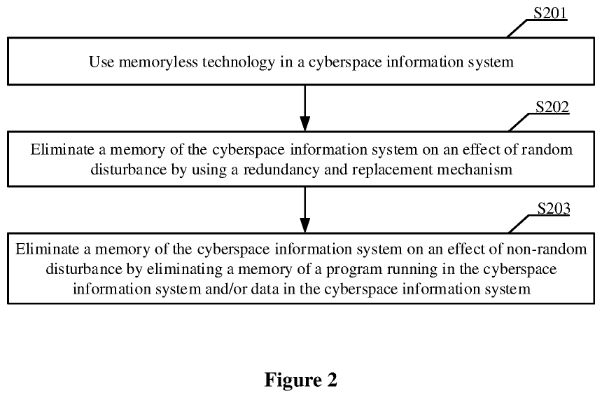

FIG. 2 is a flow chart of a security defense method applied to a network security defense system according to an embodiment of the present disclosure. The security defense method includes the following steps S201 to S203.

In step S201, memoryless technology is used in a cyberspace information system.

In the embodiment, the memoryless technology includes technology which is not affected by generalized disturbance. The generalized disturbance includes random disturbance and/or non-random disturbance.

In the embodiment, the memoryless technology may be used to make the cyberspace information system not be affected by generalized disturbance. The memoryless technology includes but is not limited to quantum technology and beam splitter (hardware). For example, in a scenario of network data replication and distribution, by means of the quantum technology and based on the feature of quantum entanglement, quantum-based data replication and distribution is not affected by the generalized disturbance.

It should be noted that quantum technology and the beam splitter (hardware) are only examples of the memoryless technology, and other technology being not affected by the generalized disturbance in the conventional technology may be used as the memoryless technology described in the embodiment, which is not limited in the embodiment.

In step S202, a memory of the cyberspace information system on an effect of the random disturbance is eliminated by using a redundancy and replacement mechanism.

The effect of the random disturbance refers to an effect of the random disturbance on the cyberspace information system.

The random disturbance at least includes: hardware or software has a decreased reliability due to a long time usage. For the effect of the random disturbance on the cyberspace information system in the embodiment, the redundancy and replacement mechanism is used, so as to eliminate the memory of the cyberspace information system on the effect of the random disturbance.

The redundancy and replacement mechanism refers to using redundant (e.g., multiple) hardware and/or software, and when one breaks down, replacing the hardware and/or software having decreased reliability with another one, so as to improve reliability. At a same moment, only one is used, and the others serve as redundant backup.

A voter (hardware) is taken as an example. Due to lifespan itself, the reliability of the voter decreases with time. For this situation, multiple voters are arranged (that is, the redundancy mechanism). When a voter used on line fails, the voter used on line is replaced with a backup voter (that is, the replacement mechanism), to improve the reliability and eliminate the effect of the random disturbance.

In step S203, a memory of the cyberspace information system on an effect of the non-random disturbance is eliminated by eliminating a memory of a program running in the cyberspace information system and/or data in the cyberspace information system.

In the embodiment, the non-random disturbance causes interference to the program and/or data in the cyberspace information system, resulting in an error generated in a program operation result and/or data. The non-random disturbance at least includes artificial disturbance. The effect of the non-random disturbance refers to an effect of the non-random disturbance on the cyberspace information system. For example, disturbance caused by artificially implanted viruses causes an error to be generated in the program operation result and/or data in the cyberspace information system.

Specifically, the program running in the cyberspace information system may include but is not limited to, a data transmission program, a domain name service program, a routing and switching program, a web service program, a file storage program and a firewall program.

In step S203, eliminating the memory of the program running in the cyberspace information system specifically refers to eliminating a memory of the program running in the cyberspace information system on the effect of the non-random disturbance.

The data stored in the cyberspace information system includes but is not limited to: configuration data, business data and user data. In step S203, eliminating the memory of the data in the cyberspace information system specifically refers to eliminating a memory of the data in the cyberspace information system on an effect of the non-random disturbance.

It should be noted that the specific implementation of eliminating the memory of the program and the specific implementation of eliminating the memory of the data will be described in detail in the following embodiments.

It should be further noted that the steps S201 to S203 described above are three steps to implement the network security defense method. However, an execution order of the three steps is not limited in the embodiment.

It can be seen from the technical solution described in the above embodiment that, in the network security defense method according to the embodiment of the present disclosure, memoryless technology is used in a cyberspace information system, a redundancy and replacement mechanism is used, and a memory of a program running in the cyberspace information system and/or data in the cyberspace information system is eliminated. The memoryless technology is used to make the cyberspace information system be not affected by the generalized disturbance, the redundancy and replacement mechanism is used to eliminate the memory of the cyberspace information system on the effect of the random disturbance, and the elimination of the memory of the program and/or data aims to eliminate the memory of the cyberspace information system on the effect of the non-random disturbance. Therefore, the present solution can block a memory (i.e., accumulation of errors) of the cyberspace information system on an error caused by the generalized disturbance, thereby improving security of the cyberspace information system.

It should be noted that the three steps of the embodiment eliminate the memory of the cyberspace information system on the generalized disturbance from different perspectives, to form an organic whole. Although the memoryless technology is not affected by the generalized disturbance, not all links in the cyberspace information system have the memoryless technology. Thus, the step of using the redundancy and replacement mechanism is proposed from a perspective of the random disturbance, and the step of eliminating the memory of the program and/or data on the effect of the non-random disturbance is proposed from a perspective of the non-random disturbance. The three steps complement each other.

Moreover, the memory elimination is innovatively proposed to improve the security of the cyberspace information system.

The three steps described above may serve as a strategy of a memory elimination module in FIG. 1, and are preconfigured in the memory elimination module. In addition, corresponding software and/or hardware are configured for other modules, to implement the above steps of the memory elimination through cooperation.

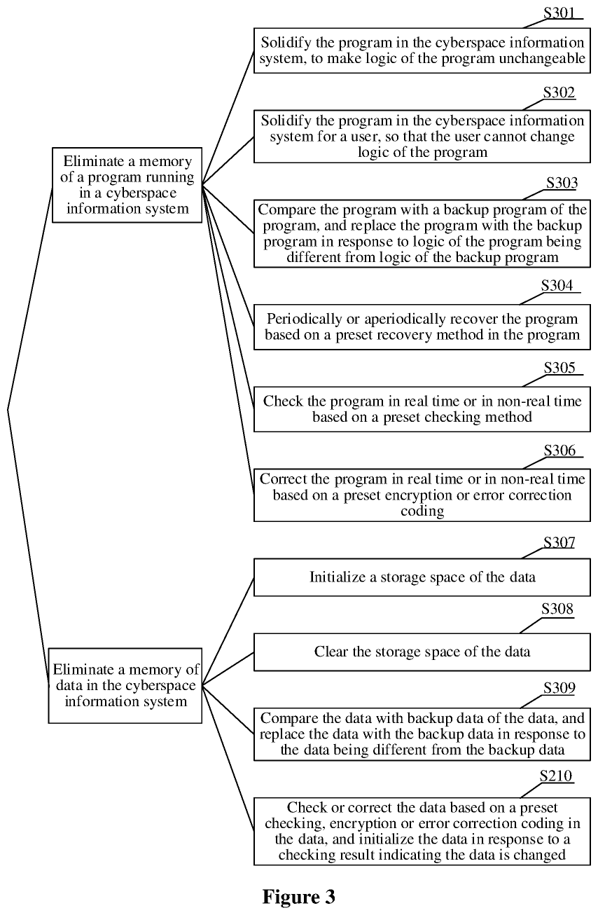

It should be noted that the memory elimination described in step S203 may be at least used to eliminate the memory of the cyberspace information system on the effect of the non-random disturbance, to avoid an error in the cyberspace information system caused by the non-random disturbance. FIG. 3 illustrates a specific implementation of the memory elimination according to the embodiment. As shown in FIG. 3, the memory elimination includes but is not limited to the following two implementations.

In a first way of the memory elimination, a memory of an effect of non-random disturbance on a program running the cyberspace information system is eliminated by eliminating a memory of the program running in the cyberspace information system.

The memory elimination of a program is implemented by the following steps S301 to S306.

In step S301, the program in the cyberspace information system is solidified, to make logic of the program unchangeable.

In the embodiment, a specific way of solidifying the program in the cyberspace information system may be that solidifying the program in a chip. For example, a replication and distribution program of a front end proxy has a simple function and can run in the chip through a logic solidification, so as to prevent the program from being tampered.

In step S302, the program in the cyberspace information system is solidified for a user, so that the user cannot change the logic of the program.

The program may be solidified such that the user cannot change the logic of the program. However, developers may change the logic of the program by using a changing tool such as FPGA, SGX, and trust zoom. The solidification method may refer to the conventional technology.

In step S303, the program is compared with a backup program of the program, and the program is replaced with the backup program in response to logic of the program being different from logic of the backup program.

It should be noted that a trigger time for comparing the program with the backup program of the program may be preset. For example, it may be preset to compare the program with the backup program of the program according to a preset cycle, or the trigger time may be preset as a time instant when an instruction for calling the program is received. A trigger time for replacing the program with the backup program may be preset. For example, the trigger time may be preset as a time instant when a comparison result indicates there is a difference between the program and the backup program, or the trigger time may be preset as a time instant when the program ends.

Specifically, an implementation of step S303 may include the following steps A1 and A2.

In step A1, the program is compared with the backup program of the program to obtain a comparison result, in response to the instruction for calling the program.

In step A2, the program is replaced with the backup program, in response to the comparison result indicating that there is a difference between the program and the backup program.

For example, a web page program may be compared with a backup source program of the web page program. When the web page program is found to be not consistent with the backup source program, the current backup program or other heterogeneous normal program is enabled to prevent an error caused by the web page program being tampered.

In step S304, the program is periodically or aperiodically recovered based on a preset recovery method in the program.

In step S305, the program is checked in real time or in non-real time based on a preset checking method.

In step S306, the program is corrected in real time or in non-real time based on preset encryption or error correction coding.

It should be noted that a trigger time for checking or correcting the program may be preset. For example, the program may be preset to be checked or corrected according to a preset cycle, or the trigger time may be preset as a time instant when an instruction for calling the program is received. A trigger time for initializing the program may be preset. For example, the trigger time may be preset as a time instant when a checking result indicates that the program is changed, or the trigger time may be preset as a time instant when the program ends.

For example, for a web page program, the web page program is checked based on a preset checking coding in the web page program. Once the web page program is found to be changed, the web page program is recovered to prevent an error caused by the web page program being tampered.

It should be noted that steps S301 to S306 are 6 implementations of eliminating the memory of the program running in the cyberspace information system. In practice, at least one of the above implementations may be applied, to eliminate the effect of the non-random disturbance on the program.

In a second way of the memory elimination, a memory of an effect of non-random disturbance on data in the cyberspace information system is eliminated by eliminating a memory of the data in the cyberspace information system.

There may be two ways to eliminate the effect of the non-random disturbance on the data. One way is to directly process the data itself, and the other way is to process a storage space of the data so as to realize processing of the data. An implementation of eliminating the memory of the data may include the following steps S307 to S310.

In step S307, a storage space of the data is initialized.

In the embodiment, the method for initializing the data includes but is not limited to a data rollback operation. It should be noted that in the embodiment, the storage space of the data is initialized according to a preset initialization rule. The initialization rule at least indicates an initialization time, and may be set according to an actual requirement. For example, the initialization rule indicates initializing the storage space of the data before the data is used, so that the data is not affected by non-random disturbance which exists before the data is used. Alternatively, the initialization rule indicates initializing the storage space of the data after the data is used, so that data existing after this use is not affected by non-random disturbance existing during this use.

For example, in response to an instruction for calling data, configuration data in a DNS domain name resolution system is compared aperiodically. Once data is found to be abnormal, original configuration data is recovered to achieve the memory elimination, and data after initialization is called.

In step S308, the storage space of the data is cleared.

In the embodiment, clearing the storage space of the data refers to deleting data in the storage space. It should be noted that in practice, different users may correspond to different storage spaces, and in the step S308, the storage spaces of different users may be cleared respectively.

Specifically, different users correspond to different storage spaces, and a memory of a storage space corresponding to each user is eliminated according to a preset cycle or in response to a preset condition.

For example, different users are registered in the cyberspace information system and managed by a central controller. The central controller may clear the storage space of each user according to the preset cycle to prevent information leakage. Alternatively, in the event of a network security incident (that is, an example of the preset condition), the central controller may quickly eliminate confidential data of all users.

In step S309, the data is compared with backup data of the data, and the data is replaced with the backup data in response to the data being different from the backup data.

It should be noted that for the implementation of the step S309, reference may be made to the above step S303, just replacing the program with the data.

In step S310, the data is checked or corrected based on a preset checking, encryption or error correction coding in the data, and the data is initialized in response to a checking result indicating the data is changed.

It should be noted that for the implementation of the step S310, reference may be made to the above step S306, just replacing the program with the data.

It should be noted that steps S307 to S310 are 4 implementations of eliminating the memory of the data in the cyberspace information system. In practice, at least one of the above steps may be applied to eliminate the effect of the non-random disturbance on the data.

It should be further noted that the above steps may be used in any combination, which is not limited herein. Moreover, the above specific steps may be implemented in hardware (e.g., FPGA), software, or a combination of software and hardware, which is not limited herein.

It can be seen from the solution provided by the above embodiments that, in the embodiment, a memory of the cyberspace information system on an effect of non-random disturbance is eliminated by eliminating a memory of a program running in the cyberspace information system and/or data in the cyberspace information system. Compared with “remediation afterwards” (such as “patching”) in the conventional technology, in the embodiment, applicant abstracts the cyberspace information system as a reconfigurable memory channel with processing capability, and innovatively proposes that the reconfigurable memory channel also has a memory for an error caused by an interference of the non-random disturbance on the reconfigurable memory channel By eliminating a memory of the effect of the non-random disturbance on the program and data in the cyberspace information system, an error caused by the non-random disturbance can be prevented in the cyberspace information system, to improve the security of the cyberspace information system.

It should be noted that although steps S301 to S310 shown in FIG. 3 are based on the conventional technology, applying these steps or a combination of the steps to network security defense, especially applying to a framework shown in FIG. 1, is an innovative achievement proposed by inventor, for the reasons as described above. That is, the inventor innovatively combines the above steps based on lemma obtained from a research process, to solve the problem of the security of the cyberspace information system.

It should be noted that since the steps shown in FIG. 3 belong to the conventional technology, those skilled in the art may carry out engineering implementation by teaching of FIG. 1 and FIG. 3, which is not repeated herein.

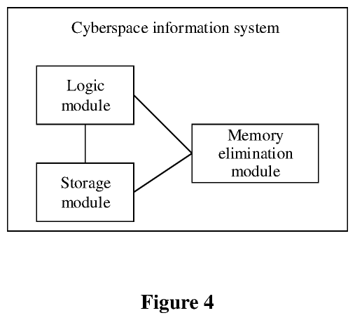

FIG. 4 is a cyberspace information system according to an embodiment of the present disclosure. The cyberspace information system includes a logic module, a storage module and a memory elimination module.

The logic module is configured to implement a logic function based on memoryless technology or a running program. Specific function may be made reference to the conventional technology. The storage module is configured to store various data generated or used by network communication. Further, the storage module may have multiple storage spaces. Different storage spaces correspond to different users. A storage space corresponding to any one of the users is configured to store data of the user. The memory elimination module is configured to eliminate memories of the program running in the function module and the data stored in the storage module. The specific implementation of a function of the memory elimination module may be made reference to the method embodiment shown in FIG. 2 or FIG. 3, which is not repeated herein.

The cyberspace information system shown in FIG. 4 may prevent the error caused by generalized disturbance through memory elimination, thereby improving the security. Moreover, it may be understood that the cyberspace information system shown in FIG. 4 has the memory elimination module to avoid the error caused by the generalized disturbance, without depending on external software or hardware, and thereby having endogenous security.

A security defense apparatus applied to a network security defense system is further provided according to an embodiment of the present disclosure. The security defense apparatus includes a memoryless module, a first memory elimination module and a second memory elimination module. The memoryless module is configured to use memoryless technology in a cyberspace information system. The memoryless technology includes technology which is not affected by generalized disturbance. The first memory elimination module is configured to eliminate an effect of time-related random disturbance on the cyberspace information system by using a redundancy and replacement mechanism. The second memory elimination module is configured to eliminate an effect of non-random disturbance on the cyberspace information system by eliminating a memory of a program running in the cyberspace information system and/or data in the cyberspace information system.

The security defense apparatus for the cyberspace information system uses the memoryless technology, uses the redundancy and replacement mechanism in the cyberspace information system, and eliminates the memories of the program and data in the cyberspace information system, to improve the security of the cyberspace information system.

A network security defense device applied to a network security defense system is further provided according to an embodiment of the present disclosure. The network security defense device includes a processor and a memory. The memory is configured to store a program. The processor is configured to run the program, to implement the network security defense method or an effect evaluation method for network security defense described above.

A computer-readable storage medium is further provided according to an embodiment of the present disclosure. The computer-readable storage medium stores a computer program. The computer program, when running on a computer, implements the network security defense method or an effect evaluation method for network security defense described above.

The embodiments in this specification are described in a progressive way, each of which emphasizes the differences from others, and the same or similar parts among the embodiments may be referred to each other. Based on the above description of the disclosed embodiments, those skilled in the art may implement or carry out the present disclosure. It is apparent for those skilled in the art to make many modifications to these embodiments. The general principle defined herein may be applied to other embodiments without departing from the spirit or scope of the present disclosure. Therefore, the present disclosure is not limited to the embodiments illustrated herein, but should be defined by the widest scope consistent with the principle and novel features disclosed herein.

1. A security defense method applied to a network security defense system, comprising:
using memoryless technology in a cyberspace information system, wherein the memoryless technology comprises technology which is not affected by generalized disturbance;
eliminating a memory of the cyberspace information system on an effect of random disturbance by using a redundancy and replacement mechanism; and
eliminating a memory of the cyberspace information system on an effect of non-random disturbance by eliminating a memory of a program running in the cyberspace information system and/or data in the cyberspace information system.

2. The method according to claim 1, wherein the eliminating a memory of a program running in the cyberspace information system comprises:
solidifying the program in the cyberspace information system, to make logic of the program unchangeable.

3. The method according to claim 1, wherein the eliminating a memory of a program running in the cyberspace information system comprises:
solidifying the program in the cyberspace information system for a user, so that logic of the program cannot be changed by the user.

4. The method according to claim 1, wherein the eliminating a memory of a program running in the cyberspace information system comprises:
comparing the program with a backup program of the program; and
replacing the program with the backup program, in response to logic of the program being different from logic of the backup program.

5. The method according to claim 1, wherein the eliminating a memory of a program running in the cyberspace information system comprises at least one of the following:
periodically or aperiodically recovering the program based on a preset recovery method in the program;
checking the program in real time or in non-real time based on a preset checking method; and
correcting the program in real time or in non-real time based on a preset encryption or error correction coding.

6. The method according to claim 1, wherein the eliminating a memory of data in the cyberspace information system comprises:
initializing a storage space of the data.

7. The method according to claim 1, wherein the eliminating a memory of data in the cyberspace information system comprises:
clearing a storage space of the data.

8. The method according to claim 1, wherein the eliminating a memory of data in the cyberspace information system comprises:
comparing the data with backup data of the data; and
replacing the data with the backup data, in response to the data being different from the backup data.

9. The method according to claim 1, wherein the eliminating a memory of data in the cyberspace information system comprises:
checking or correcting the data based on a preset checking, encryption or error correction coding in the data; and
initializing the data, in response to a checking result indicating the data is changed.

10. A security defense apparatus applied to a network security defense system, comprising:
a memoryless module, configured to use memoryless technology in a cyberspace information system, wherein the memoryless technology comprises technology which is not affected by generalized disturbance;
a first memory elimination module, configured to eliminate an effect of time-related random disturbance on the cyberspace information system by using a redundancy and replacement mechanism; and
a second memory elimination module, configured to eliminate an effect of non-random disturbance on the cyberspace information system by eliminating a memory of a program running in the cyberspace information system and/or data in the cyberspace information system.

11. A security defense device applied to a network security defense system, comprising a processor and a memory, wherein
the memory is configured to store a program; and
the processor is configured to run the program, to implement the security defense method applied to the network security defense system according to claim 1.

12. A computer-readable storage medium, storing a computer program, wherein, the computer program, when running on a computer, implements the security
defense method applied to the network security defense system according to claim 1.

13. A cyberspace information system, comprising:
a logic module, a storage module and a memory elimination module, wherein
the logic module is configured to implement a logic function based on memoryless technology or a running program;
the storage module is configured to store data; and
the memory elimination module is configured to perform the security defense method applied to the network security defense system according to claim 1, to eliminate an effect of generalized disturbance on the network security defense system.
